(19) United States
(12) Patent Application Publication
(10) Pub. No.: US 2006/0100991 A1
(43) Pub. Date: May 11, 2006

(54) Method for dynamical determination of actions to perform on a selected item in a web portal GUI environment

(75) Inventors: John Mark Hartel, Austin, TX (US); Joseph Laurence Saunders, Austin, TX (US); Gary Thomas Barta, Round Rock, TX (US); Shobha Venkateswaran, Austin, TX (US)

Correspondence Address: IBM CORPORATION;C/O DARCELL WALKER, ATTORNEY AT LAW, 9301 SOUTHWEST FREEWAY, SUITE 250, HOUSTON, TX, 77074, US

(73) Assignee: International Business Machines Corporation, Armonk, NY (US)

(21) Appl. No.: 10/970,463

(22) Filed: Oct. 21, 2004

(51) Int. Cl. G06F 17/30

(52) U.S. Cl. 707/3

(57) ABSTRACT

The idea of the present invention is to define a set of rules that: determine the set of actions that apply based on the context of a selected object and UI operating system environment (known hereafter as Filter Rules), determine for a selected action it's input values, again based on the above context (known hereafter as Input Rules) and determine the set of backend tasks to run in order to perform that action (known here after as Task Rules). A software engine is postulated that will consume these rules, performing the operations described above. The advantages of such an implementation are a system that can be adapted to changing conditions by altering or augmenting the rules in its database.

### FIELD OF THE INVENTION

The present invention relates to a graphical user interface and in particular to a method for dynamically determining the actions to perform on a selected item of a graphical user interface in a web portal graphical user interface environment.

### BACKGROUND OF THE INVENTION

Various types of communication devices have been made available for the purpose of making the intended communication easier, faster and/or more efficient. Facsimile machines and personal computers (PCs) are examples of such devices. One such development is the creation of a graphical user interface (GUI). A GUI is a program interface that uses the computer's graphics capabilities to make the program easier to use. Well-designed graphical user interfaces can free the user from learning complex command languages. On the other hand, many users find that they work more effectively with a command driven interface, especially if they already know the command language. Graphical user interfaces, such as Microsoft Windows and the one used by the Apple Macintosh, feature the following basic components:
pointer: A symbol that appears on the display screen and that you move to select objects and commands. Usually, the pointer appears as a small angled arrow. Text processing applications, however, use an I-beam pointer that is shaped like a capital I.
pointing device: A device, such as a mouse or trackball, which enables you to select objects on the display screen.
icons: Small pictures that represent commands, files, or windows. By moving the pointer to the icon and pressing a mouse button, you can execute a command or convert the icon into a window. You can also move the icons around the display screen as if they were real objects on your desk.
desktop: The area on the display screen where icons are grouped is often referred to as the desktop because the icons are intended to represent real objects on a real desktop.
windows: You can divide the screen into different areas. In each window, you can run a different program or display a different file. You can move windows around the display screen, and change their shape and size at will.
menus: Most graphical user interfaces let you execute commands by selecting a choice from a menu.

Many graphical user interfaces are context-based systems. In a context-based system a list of objects (icons) is displayed on the screen. The objects for example could represent various files (i.e. Microsoft Explorer on the desk top). Connected with the icon is a set/menu of operations that would be displayed by right click of the icon. The operations in the menu are operations against the selected item. In an example, if the selected object was a file, one of the operations that would appear could be the ‘delete’ operation.

In current systems, the operations that can be performed on a given object are hard coded. This hard coded design limits the range of operations to only the hard coded operations. If there were a desire to perform an operation that was not hard coded, it would be necessary to hard code that operation to the object.

There remains a need for a graphic user interface method and system that can perform dynamically determination of actions to be performed on a selected item in a web portal graphic user interface environment

### SUMMARY OF THE INVENTION

It is one objective of the present invention to provide a method and system, which can dynamically determine operations for objects in a graphical interface user environment.

It is a second objective of the present invention to create a set of filter rules used by the method and system of the present invention to dynamically determine the actions that can be performed on a selected object.

It is a third objective of the present invention to create a set of input rules used by the method and system of the present invention to dynamically determine the tasks necessary to perform the selected action.

It is a fourth objective of the present invention to create a set of task rules used by the method and system of the present invention to dynamically determine the steps to implement in the execution of the tasks necessary to perform the selected action.

The present invention defines a set of rules that: 1) determine the set of actions that apply to a selected object based on the context of a selected object and UI operating system environment (known hereafter as Filter Rules); 2) determine, for a selected action a set of input values, using a set of Input rules); 3) and determine the set of backend tasks to run in order to perform that action (known here after as Task Rules). A software engine consumes these rules, performing the operations described above. The advantages of such an implementation are a system that can be adapted to changing conditions by altering or augmenting the rules in its database.

Typically, the actions to perform can change based on the state of the selected object and the user interface's current operating environment. (This operating environment is referred to as the current operating “context”.) Once an object is selected for execution, there can also be a set of input values that the action requires. These input values also can change based on the operating context of the UI. Lastly, each action will map to one or more backend tasks that need to be run (consuming the input values) in order to satisfy the action's contact with the user. Previous solutions to this problem usually involve programmatically hard-coding these rules to determine actions, inputs and backend tasks for a given selected object. This can result in systems that are not easily adaptable to changes to their operating environments and installed configuration.

In an example, there can be an object (icon) on a user's desktop. If the user right clicks on that object, a popup menu will appear as with conventional systems. However, in the present invention, the items in the menu would vary from time to time depending on the current operating environment in which the user selected the object. As mentioned, with conventional systems, the items in the popup are constant regardless of the operating environment. If the user selected one of the items such as “Print”, the next phase of the invention would be to generate a set of inputs that would be used in the implementation of that action. This phase would also generate the set of tasks to be performed to implement the “Print” action. Internally, there may be several tasks required to perform the “Print” action. The tasks would use the generated inputs during the implementation of the tasks. During each phase, the various sets of XML rules would determine the actions, inputs and tasks for implementation.

### DESCRIPTION OF THE DRAWINGS

FIG. 1 is a terminal screen displaying conventional graphic user interface icons.

FIG. 2 is an example of a conventional graphics user interface icon and associated actions with that icon.

FIG. 3 is a configuration of the method and system of the present invention.

FIG. 4 is a general flow diagram of the steps in the implementation of the method of the present invention.

FIG. 5 is a flow diagram illustrating the steps in the action filter process of the present invention.

FIG. 6 is a flow diagram illustrating the steps in the action input process of the present invention.

FIG. 7 is a flow diagram illustrating the steps in the action task process of the present invention.

FIG. 8 is a diagram illustrating a data flow sequence of the implementation of the method of present invention.

### DETAILED DESCRIPTION OF THE INVENTION

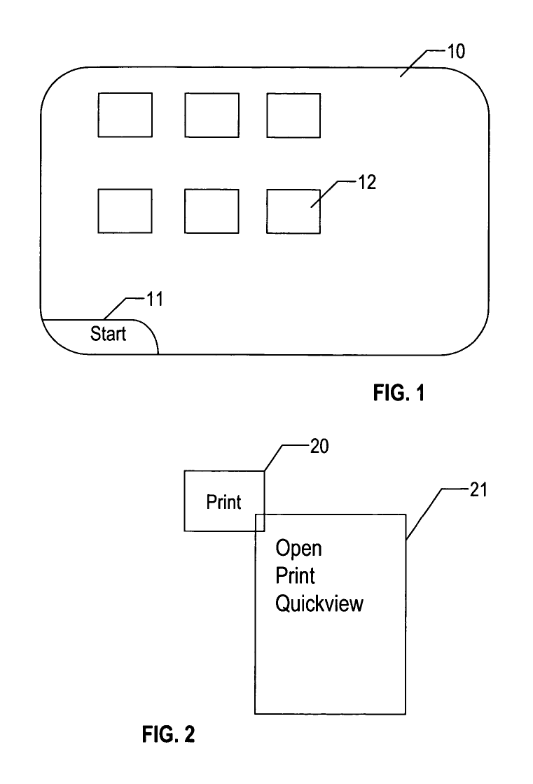

The present invention comprises a method and system for dynamic determination of actions to perform on a selected item in a web portal graphic user interface (GUI) environment. As previously defined, a GUI is a program interface that uses the computer's graphics capabilities to make the program easier to use. Referring to FIG. 1, shown is a terminal screen 10 for a computer containing GUI software can be initiated through a start icon 11 and object icons 12. FIG. 2 illustrates the “PRINT” icon 20 as a GUI object. Clicking this ‘PRINT’ icon will display several actions that a user can select. The actions are displayed in the form of a window 21 that contains a menu of items that represents each action available to the user for that GUI object. As shown, for the “Print” icon, there exist several actions that be performed on that icon. In this particular example, the start object has ‘Open’, ‘Print’ and ‘Quickview’ that can be performed on that object. As mentioned, with the conventional GUI technology, each action is hardwired, making the system very rigid and burdensome to change an action in the GUI.

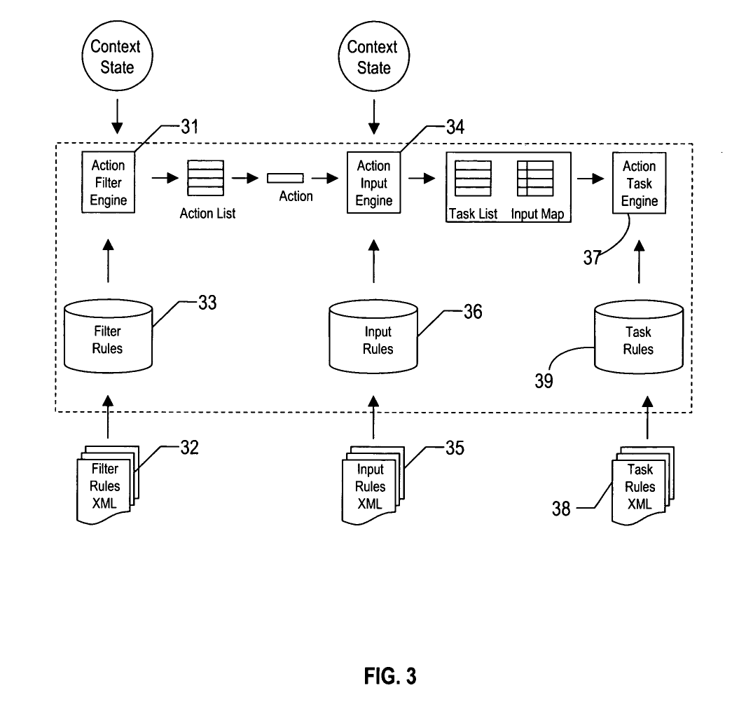

The implementation of this invention is intended to have objects with associated actions that are dynamic and dependent on the present environment of the object. FIG. 3 illustrates a configuration of the system of the present invention. This system comprises three main components. The components are implemented in three different stages. These components and their interactions are discussed in the following descriptions. Referring to FIG. 3, the first component is the Action Filter Engine. The Action Filter Engine 31 is a software subcomponent that applies filter rules to the input context state. The Context State is a set of data items used to quantify the current state of the system. They provide the current operating context to the Action Broker Engine.

These items include:

The selected data object properties

The portlet request attributes

The portlet session attributes

The roles of the user

Referring again to FIG. 3, the filter rules 32 are created in an XML schema format. This XML document describes a set of Filter Rules. It is used to install new rules into the filter rules database 33. The filter rules database is used to filter a set of actions into a subset that applies for the given context state. Filter rules determine actions that can be performed on an object in a given environment (context) based on for example:

Data type of a selected data object

Property values of a selected data object

Attribute values of the portlet request state

Attribute values of the portlet session state

Roles of the user

Below is an XML schema for the filter rules 32 in accordance with the present invention:

Action Filter

```
<?xml version=“1.0” encoding=“UTF-8”?>
<xsd:schema xmlns:xsd=“http://www.w3.org/2001/XMLSchema”>
  <xsd:element name=“ActionFilters”>
    <xsd:annotation>
      <xsd:documentation>This defines a set of user actions filters.
      </xsd:documentation>
    </xsd:annotation>
    <xsd:complexType>
      <xsd:sequence>
        <xsd:element maxOccurs=“unbounded” minOccurs=“1” ref=“ActionFilter”/>
      </xsd:sequence>
    </xsd:complexType>
  </xsd:element>
  <xsd:element name=“ActionFilter”>
    <xsd:annotation>
      <xsd:documentation>This defines a filter used to
        determine which user actions may be run on a selected
        object.
      </xsd:documentation>
    </xsd:annotation>
    <xsd:complexType>
      <xsd:sequence>
        <xsd:element ref=“Filters”/>
        <xsd:element ref=“UserActionRefs”/>
      </xsd:sequence>
    </xsd:complexType>
  </xsd:element>
  <xsd:element name=“Filters”>
    <xsd:annotation>
      <xsd:documentation>This encloses a set of expressions that make up the filter.
      </xsd:documentation>
    </xsd:annotation>
    <xsd:complexType>
      <xsd:choice maxOccurs=“unbounded” minOccurs=“0”>
        <xsd:element ref=“RoleFilter”/>
        <xsd:element ref=“ClassFilter”/>
        <xsd:element ref=“PropertyFilter”/>
        <xsd:element ref=“FunctionFilter”/>
        <xsd:element ref=“ContextFilter”/>
      </xsd:choice>
    </xsd:complexType>
  </xsd:element>
  <xsd:element name=“RoleFilter”>
    <xsd:annotation>
      <xsd:documentation>This expression filters on the user's role.
      </xsd:documentation>
    </xsd:annotation>
    <xsd:complexType>
      <xsd:attribute name=“role” type=“xsd:string” use=“required”>
        <xsd:annotation>
            <xsd:documentation>The required roles of the user, delimited by commas.
          </xsd:documentation>
        </xsd:annotation>
      </xsd:attribute>
    </xsd:complexType>
  </xsd:element>
  <xsd:element name=“PropertyFilter”>
    <xsd:annotation>
      <xsd:documentation> This expression filters on the value
        of a selected object&apos;s property.
      </xsd:documentation>
    </xsd:annotation>
    <xsd:complexType>
      <xsd:attribute name=“property” type=“xsd:string” use=“required”>
        <xsd:annotation>
            <xsd:documentation>The name of a property of the selected object
            from which to access the value. Java introspection is
            used to access the property. (The Java convention for
            naming bean properties must be followed.)
          </xsd:documentation>
        </xsd:annotation>
      </xsd:attribute>
      <xsd:attribute name=“pattern” type=“xsd:string” use=“required”>
        <xsd:annotation>
            <xsd:documentation>The compare pattern.
          </xsd:documentation>
        </xsd:annotation>
      </xsd:attribute>
      <xsd:attribute default=“regex” name=“matching”>
        <xsd:annotation>
            <xsd:documentation>The matching algorithm to use.
            &quot;regex&quot; indicates use of regular
            expression matching, &quot;string&quot; indicates use of
            exact string matching and &quot;stringIgnoreCase&quot;
            indicates use of string matching but ignores
            the case.
          </xsd:documentation>
        </xsd:annotation>
        <xsd:simpleType>
          <xsd:restriction base=“xsd:string”>
            <xsd:enumeration value=“regex”/>
            <xsd:enumeration value=“string”/>
            <xsd:enumeration value=“stringIgnoreCase”/>
          </xsd:restriction>
        </xsd:simpleType>
      </xsd:attribute>
      <xsd:attribute default=“false” name=“not”>
        <xsd:annotation>
            <xsd:documentation>Applies the
            NOT boolean operator to the compare results.
          </xsd:documentation>
        </xsd:annotation>
        <xsd:simpleType>
          <xsd:restriction base=“xsd:string”>
            <xsd:enumeration value=“false”/>
            <xsd:enumeration value=“true”/>
          </xsd:restriction>
        </xsd:simpleType>
      </xsd:attribute>
    </xsd:complexType>
  </xsd:element>
  <xsd:element name=“FunctionFilter”>
    <xsd:annotation>
      <xsd:documentation>This expression filters on the return value
        of a selected object&apos;s method function.
      </xsd:documentation>
    </xsd:annotation>
    <xsd:complexType>
      <xsd:attribute name=“methodName” type=“xsd:string” use=“required”>
        <xsd:annotation>
            <xsd:documentation>The method to call on the selected object.
          </xsd:documentation>
        </xsd:annotation>
      </xsd:attribute>
      <xsd:attribute name=“argName” type=“xsd:string” use=“optional”>
        <xsd:annotation>
            <xsd:documentation>The string argument to pass to the method.
            If not specified, no argurment is passed.
          </xsd:documentation>
        </xsd:annotation>
      </xsd:attribute>
      <xsd:attribute name=“pattern” type=“xsd:string” use=“required”>
        <xsd:annotation>
            <xsd:documentation>The compare pattern.
          </xsd:documentation>
        </xsd:annotation>
      </xsd:attribute>
      <xsd:attribute default=“regex” name=“matching”>
        <xsd:annotation>
            <xsd:documentation>The matching algorithm to use.
            &quot;regex&quot; indicates use of regular
            expression matching, &quot;string&quot; indicates use of
            exact string matching and &quot;stringIgnoreCase&quot;
            indicates use of string matching but ignores
            the case.
          </xsd:documentation>
        </xsd:annotation>
        <xsd:simpleType>
          <xsd:restriction base=“xsd:string”>
            <xsd:enumeration value=“regex”/>
            <xsd:enumeration value=“string”/>
            <xsd:enumeration value=“stringIgnoreCase”/>
          </xsd:restriction>
        </xsd:simpleType>
      </xsd:attribute>
      <xsd:attribute default=“false” name=“not”>
        <xsd:annotation>
            <xsd:documentation>Applies the
            NOT boolean operator to the compare results.
          </xsd:documentation>
        </xsd:annotation>
        <xsd:simpleType>
          <xsd:restriction base=“xsd:string”>
            <xsd:enumeration value=“false”/>
            <xsd:enumeration value=“true”/>
          </xsd:restriction>
        </xsd:simpleType>
      </xsd:attribute>
    </xsd:complexType>
  </xsd:element>
  <xsd:element name=“ContextFilter”>
    <xsd:annotation>
      <xsd:documentation> This expression filters on the value
        of an existing context item. This item is accessed
        from the portlet request or session object.
      </xsd:documentation>
    </xsd:annotation>
    <xsd:complexType>
      <xsd:attribute name=“name” type=“xsd:string” use=“required”>
        <xsd:annotation>
            <xsd:documentation>The name of the context value.
          </xsd:documentation>
        </xsd:annotation>
      </xsd:attribute>
      <xsd:attribute name=“property” type=“xsd:string” use=“optional”>
        <xsd:annotation>
            <xsd:documentation>The name of a property of the context value
            object from which to access the value.
            When not specified, the object itself is
            used as the value. Java introspection is
            used to access the property. (The Java convention for
            naming bean properties must be followed.)
          </xsd:documentation>
        </xsd:annotation>
      </xsd:attribute>
      <xsd:attribute name=“pattern” type=“xsd:string” use=“required”>
        <xsd:annotation>
            <xsd:documentation>The compare pattern.
          </xsd:documentation>
        </xsd:annotation>
      </xsd:attribute>
      <xsd:attribute default=“regex” name=“matching”>
        <xsd:annotation>
            <xsd:documentation>The matching algorithm to use.
            &quot;regex&quot; indicates use of regular
            expression matching, &quot;string&quot; indicates use of
            exact string matching and &quot;stringIgnoreCase&quot;
            indicates use of string matching but ignores
            the case.
          </xsd:documentation>
        </xsd:annotation>
        <xsd:simpleType>
          <xsd:restriction base=“xsd:string”>
            <xsd:enumeration value=“regex”/>
            <xsd:enumeration value=“string”/>
            <xsd:enumeration value=“stringIgnoreCase”/>
          </xsd:restriction>
        </xsd:simpleType>
      </xsd:attribute>
      <xsd:attribute default=“false” name=“not”>
        <xsd:annotation>
            <xsd:documentation>Applies the
            NOT boolean operator to the compare results.
          </xsd:documentation>
        </xsd:annotation>
        <xsd:simpleType>
          <xsd:restriction base=“xsd:string”>
            <xsd:enumeration value=“false”/>
            <xsd:enumeration value=“true”/>
          </xsd:restriction>
        </xsd:simpleType>
      </xsd:attribute>
      <xsd:attribute default=“session” name=“scope”>
        <xsd:annotation>
            <xsd:documentation>The data source of the context value.
            &quot;Request&quot; scope accesses the
            portlet request object. &quot;Session&quot; scope
            accesses the portlet session object.
          </xsd:documentation>
        </xsd:annotation>
        <xsd:simpleType>
          <xsd:restriction base=“xsd:string”>
            <xsd:enumeration value=“request”/>
            <xsd:enumeration value=“session”/>
          </xsd:restriction>
        </xsd:simpleType>
      </xsd:attribute>
    </xsd:complexType>
  </xsd:element>
  <xsd:element name=“ClassFilter”>
    <xsd:annotation>
      <xsd:documentation> This expression filters on the value
        of a selected object&apos;s class type.
      </xsd:documentation>
    </xsd:annotation>
    <xsd:complexType>
      <xsd:attribute name=“pattern” type=“xsd:string” use=“required”>
        <xsd:annotation>
            <xsd:documentation>The compare pattern.
          </xsd:documentation>
        </xsd:annotation>
      </xsd:attribute>
      <xsd:attribute default=“regex” name=“matching”>
        <xsd:annotation>
            <xsd:documentation>The matching algorithm to use.
            &quot;regex&quot; indicates use of regular
            expression matching, &quot;string&quot; indicates use of
            exact string matching and &quot;stringIgnoreCase&quot;
            indicates use of string matching but ignore
            the case.
          </xsd:documentation>
        </xsd:annotation>
        <xsd:simpleType>
          <xsd:restriction base=“xsd:string”>
            <xsd:enumeration value=“regex”/>
            <xsd:enumeration value=“string”/>
            <xsd:enumeration value=“stringIgnoreCase”/>
          </xsd:restriction>
        </xsd:simpleType>
      </xsd:attribute>
      <xsd:attribute default=“false” name=“not”>
        <xsd:annotation>
            <xsd:documentation>Applies the
            NOT boolean operator to the compare results.
          </xsd:documentation>
        </xsd:annotation>
        <xsd:simpleType>
          <xsd:restriction base=“xsd:string”>
            <xsd:enumeration value=“false”/>
            <xsd:enumeration value=“true”/>
          </xsd:restriction>
        </xsd:simpleType>
      </xsd:attribute>
    </xsd:complexType>
  </xsd:element>
  <xsd:element name=“UserActionRefs”>
    <xsd:annotation>
      <xsd:documentation> This encloses a set of user action
        references.
      </xsd:documentation>
    </xsd:annotation>
    <xsd:complexType>
      <xsd:sequence>
        <xsd:element maxOccurs=“unbounded” minOccurs=“1”
ref=“UserActionRef”/>
      </xsd:sequence>
    </xsd:complexType>
  </xsd:element>
  <xsd:element name=“UserActionRef”>
    <xsd:annotation>
      <xsd:documentation> This is a reference to an
        existing user action defined in the action input XML file.
      </xsd:documentation>
    </xsd:annotation>
    <xsd:complexType>
      <xsd:attribute name=“name” type=“xsd:string” use=“required”>
        <xsd:annotation>
            <xsd:documentation>The name of the user action reference.
          </xsd:documentation>
        </xsd:annotation>
      </xsd:attribute>
    </xsd:complexType>
  </xsd:element>
</xsd:schema>
```

The output of the Action Filter Engine is the list of actions that passed the filter rules. This actions list represents the actions that can be performed on an object based on the current object context. This list is analogous to the popup windows containing a menu of available actions.

The second component of the system of the present invention is an Action input Engine 34. The Action Input Engine is a software subcomponent that generates inputs for a selected object action based a set of input rules 35. These input rules determine the inputs in response to the selected action and the context state of the object. The output of the Action Input Engine is a set of name/value pairs comprising a context state (input map) and a list of tasks to execute. The set of input rules 35 is described and defined in an XML document. The input rules reside in a rules database 36. The Action Input Engine applies these input rules based on the context state and an action chosen from the Action list by the user. Based on the application of these rules to the selected action, the Action Input Engine generates a set of name/value pairs (input map) and a list of tasks to associate with an action. Input map values may be extracted from the following sources:

Properties of the selected data object

Attributes from the portlet request state

Attributes from the portlet session state

Defined constants

Below is an XML schema for the input rules 35 in accordance with the present invention:

Action Input

```
?xml version=“1.0” encoding=“UTF-8”?>
<xsd:schema xmlns:xsd=“http://www.w3.org/2001/XMLSchema”>
  <xsd:element name=“ActionInputs”>
    <xsd:annotation>
      <xsd:documentation> This defines a set of user actions.
      </xsd:documentation>
    </xsd:annotation>
    <xsd:complexType>
      <xsd:sequence>
        <xsd:element maxOccurs=“unbounded” minOccurs=“1” ref=“UserAction”/>
      </xsd:sequence>
    </xsd:complexType>
  </xsd:element>
  <xsd:element name=“UserAction”>
    <xsd:annotation>
      <xsd:documentation> This defines a user action, its input and its
        implementation tasks.
      </xsd:documentation>
    </xsd:annotation>
    <xsd:complexType>
      <xsd:sequence>
        <xsd:element ref=“Name”/>
        <xsd:element ref=“Input”/>
        <xsd:element ref=“Tasks”/>
      </xsd:sequence>
      <xsd:attribute name=“name” type=“xsd:string” use=“required”>
        <xsd:annotation>
            <xsd:documentation>Identifier for the action, must be unique.
          </xsd:documentation>
        </xsd:annotation>
      </xsd:attribute>
    </xsd:complexType>
  </xsd:element>
  <xsd:element name=“Name”>
    <xsd:annotation>
      <xsd:documentation>This defines the name string that is to be
        displayed to the user for action selection. If no
        attributes are specified, the string enclosed by the
        tag is used.
      </xsd:documentation>
    </xsd:annotation>
    <xsd:complexType>
      <xsd:simpleContent>
        <xsd:extension base=“xsd:string”>
          <xsd:attribute name=“key” type=“xsd:string” use=“optional”>
            <xsd:annotation>
                <xsd:documentation>The translated string lookup key.
              </xsd:documentation>
            </xsd:annotation>
          </xsd:attribute>
          <xsd:attribute name=“resourceBundle”
            type=“xsd:string” use=“optional”>
            <xsd:annotation>
                <xsd:documentation>The translated string resource bundle.
              </xsd:documentation>
            </xsd:annotation>
          </xsd:attribute>
        </xsd:extension>
      </xsd:simpleContent>
    </xsd:complexType>
  </xsd:element>
  <xsd:element name=“Input”>
    <xsd:annotation>
      <xsd:documentation>This encloses a set of values to use as the action input.
      </xsd:documentation>
    </xsd:annotation>
    <xsd:complexType>
      <xsd:choice maxOccurs=“unbounded” minOccurs=“0”>
        <xsd:element ref=“UseContext”/>
        <xsd:element ref=“UseProperty”/>
        <xsd:element ref=“UseFunction”/>
        <xsd:element ref=“UseConstant”/>
      </xsd:choice>
    </xsd:complexType>
  </xsd:element>
  <xsd:element name=“UseContext”>
    <xsd:annotation>
      <xsd:documentation>This defines the value of a context object to use as input.
      </xsd:documentation>
    </xsd:annotation>
    <xsd:complexType>
      <xsd:attribute name=“name” type=“xsd:string” use=“required”>
        <xsd:annotation>
            <xsd:documentation>The name of the input value.
          </xsd:documentation>
        </xsd:annotation>
      </xsd:attribute>
      <xsd:attribute name=“fetchName” type=“xsd:string” use=“optional”>
        <xsd:annotation>
            <xsd:documentation>The name of the object to fetch from the context.
          </xsd:documentation>
        </xsd:annotation>
      </xsd:attribute>
      <xsd:attribute name=“property” type=“xsd:string” use=“optional”>
        <xsd:annotation>
            <xsd:documentation>The name of a property of the context value object
            from which to access the value. When not specified, the object itself is used
            as the value. Java introspection is
            used to access the property. (The Java convention for
            naming bean properties must be followed.)
          </xsd:documentation>
        </xsd:annotation>
      </xsd:attribute>
      <xsd:attribute default=“session” name=“scope”>
        <xsd:annotation>
            <xsd:documentation>The data source of the context value.
            &quot;Request&quot; scope accesses the
            portlet request object. &quot;Session&quot; scope
            accesses the portlet session object.
          </xsd:documentation>
        </xsd:annotation>
        <xsd:simpleType>
          <xsd:restriction base=“xsd:string”>
            <xsd:enumeration value=“request”/>
            <xsd:enumeration value=“session”/>
          </xsd:restriction>
        </xsd:simpleType>
      </xsd:attribute>
    </xsd:complexType>
  </xsd:element>
  <xsd:element name=“UseProperty”>
    <xsd:annotation>
      <xsd:documentation>This defines the value of a property of
        the selected object to use as input.
      </xsd:documentation>
    </xsd:annotation>
    <xsd:complexType>
      <xsd:attribute name=“name” type=“xsd:string” use=“required”>
        <xsd:annotation>
            <xsd:documentation>The name of the input value.
          </xsd:documentation>
        </xsd:annotation>
      </xsd:attribute>
      <xsd:attribute name=“property” type=“xsd:string” use=“required”>
        <xsd:annotation>
            <xsd:documentation>The name of a property of the selected object.
            Java introspection is used to access the property.
            (The Java convention for naming bean
            properties must be followed.)
          </xsd:documentation>
        </xsd:annotation>
      </xsd:attribute>
    </xsd:complexType>
  </xsd:element>
  <xsd:element name=“UseFunction”>
    <xsd:annotation>
      <xsd:documentation>This defines the return value of a method
        function on the selected object to
        use as input.
      </xsd:documentation>
    </xsd:annotation>
    <xsd:complexType>
      <xsd:attribute name=“name” type=“xsd:string” use=“required”>
        <xsd:annotation>
            <xsd:documentation>The name of the input value.
          </xsd:documentation>
        </xsd:annotation>
      </xsd:attribute>
      <xsd:attribute name=“methodName” type=“xsd:string” use=“required”>
        <xsd:annotation>
            <xsd:documentation>The method to call on the selected object.
          </xsd:documentation>
        </xsd:annotation>
      </xsd:attribute>
      <xsd:attribute name=“argName” type=“xsd:string” use=“optional”>
        <xsd:annotation>
            <xsd:documentation>The string argument to pass to the method.
            If not specified, no argurment is passed.
          </xsd:documentation>
        </xsd:annotation>
      </xsd:attribute>
    </xsd:complexType>
  </xsd:element>
  <xsd:element name=“UseConstant”>
    <xsd:annotation>
      <xsd:documentation>This defines an constant value to
        use as input.
      </xsd:documentation>
    </xsd:annotation>
    <xsd:complexType>
      <xsd:attribute name=“name” type=“xsd:string” use=“required”>
        <xsd:annotation>
            <xsd:documentation>The name of the input value.
          </xsd:documentation>
        </xsd:annotation>
      </xsd:attribute>
      <xsd:attribute name=“value” type=“xsd:string” use=“required”>
        <xsd:annotation>
            <xsd:documentation>The constant value.
          </xsd:documentation>
        </xsd:annotation>
      </xsd:attribute>
    </xsd:complexType>
  </xsd:element>
  <xsd:element name=“Tasks”>
    <xsd:annotation>
      <xsd:documentation> This encloses a set of tasks to run.
      </xsd:documentation>
    </xsd:annotation>
    <xsd:complexType>
      <xsd:sequence>
        <xsd:element maxOccurs=“unbounded” minOccurs=“0” ref=“TaskRef”/>
      </xsd:sequence>
    </xsd:complexType>
  </xsd:element>
  <xsd:element name=“TaskRef”>
    <xsd:annotation>
      <xsd:documentation>This defines a reference to a task.
        This task is defined in the action task
        XML file.
      </xsd:documentation>
    </xsd:annotation>
    <xsd:complexType>
      <xsd:attribute name=“name” type=“xsd:string” use=“required”>
        <xsd:annotation>
            <xsd:documentation>The name of the task reference.
          </xsd:documentation>
        </xsd:annotation>
      </xsd:attribute>
    </xsd:complexType>
  </xsd:element>
</xsd:schema>
```

Referring again to FIG. 3, the third component of the present invention is the Action Task Engine 37. This Action Task Engine is a software subcomponent that executes the input list of tasks according to the task rules, and the input map that is fed to each executed task as an input. The task rules are set rules 38 that reside in database 39 and are used to execute a given list of tasks with a given set of name/value pairs (input map) as input. The Action Task Engine determines what steps are necessary to perform the tasks on the tasks list. While custom actions may be defined and plugged in, the following set of tasks are built into the Action Task Engine:

Launch an ISC page, sending the input (input map) to it as a context change event.

Launch a portlet, sending the input (input map) to it as a context change event.

Broadcast input (input map) to all portlets on the current ISC page as a context change event.

Below is an XML schema for the task rules 38 in accordance with the present invention:

Task Filter

```
?xml version=“1.0” encoding=“UTF-8”?>
<xsd:schema xmlns:xsd=“http://www.w3.org/2001/XMLSchema”>
  <xsd:element name=“ActionTasks”>
    <xsd:annotation>
      <xsd:documentation> This defines a list of action tasks.
      </xsd:documentation>
    </xsd:annotation>
    <xsd:complexType>
      <xsd:sequence>
        <xsd:element maxOccurs=“unbounded” minOccurs=“1”
        ref=“Task”/>
      </xsd:sequence>
    </xsd:complexType>
  </xsd:element>
  <xsd:element name=“Task”>
    <xsd:annotation>
      <xsd:documentation> This defines an action task to be
        run.
      </xsd:documentation>
    </xsd:annotation>
    <xsd:complexType>
      <xsd:sequence>
        <xsd:element maxOccurs=“unbounded” minOccurs=“0”
ref=“ControlParameter”/>
      </xsd:sequence>
      <xsd:attribute name=“name” type=“xsd:string” use=“required”>
        <xsd:annotation>
            <xsd:documentation>Identifier for the task, must be unique.
          </xsd:documentation>
        </xsd:annotation>
      </xsd:attribute>
      <xsd:attribute name=“className” type=“xsd:string”
      use=“required”>
        <xsd:annotation>
            <xsd:documentation>Class name of the Java object to
            execute in order to implement the task.
          </xsd:documentation>
        </xsd:annotation>
      </xsd:attribute>
    </xsd:complexType>
  </xsd:element>
  <xsd:element name=“ControlParameter”>
    <xsd:annotation>
      <xsd:documentation> This defines a control parameter to
        pass to the executed Java object that implements the task.
      </xsd:documentation>
    </xsd:annotation>
    <xsd:complexType>
      <xsd:attribute name=“name” type=“xsd:string” use=“required”>
        <xsd:annotation>
            <xsd:documentation>Name of the control parameter.
          </xsd:documentation>
        </xsd:annotation>
      </xsd:attribute>
      <xsd:attribute name=“value” type=“xsd:string” use=“required”>
        <xsd:annotation>
            <xsd:documentation>Value for the control parameter.
          </xsd:documentation>
        </xsd:annotation>
      </xsd:attribute>
    </xsd:complexType>
  </xsd:element>
</xsd:schema>
```

The use of the XML format to define the filter, context and task rules provides flexibility in implementing the rules. In the present invention, a system administrator, system installer or other person responsible for the installation and maintenance of the method of the present invention can modify the rules as desired using the XML format.

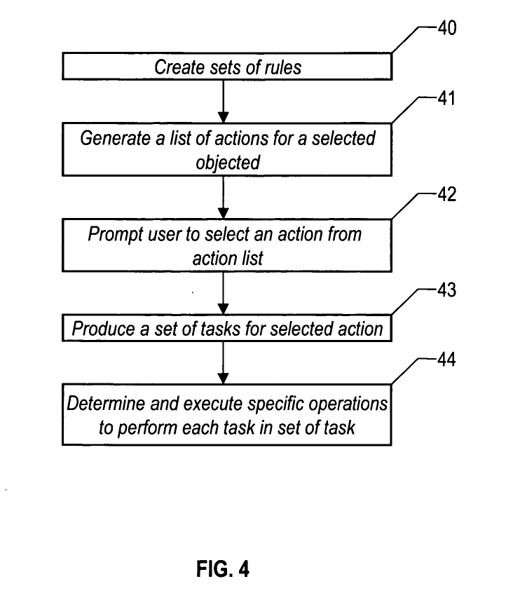

FIG. 4 is a general flow diagram of the steps in the implementation of the method of the present invention. The first step 40 in the process of the present invention is to create the multiple sets of rules that will be used in the three stages of the present invention. Step 41 generates a set of actions (Action List) that can be performed on a selected object. This action-generating step occurs at the Action Filter Engine. Following the generation of the action list, the user is prompted to select on of the actions in step 42. The action list is generated by retrieving filter rules and applying these rules to the selected object in view of the define object context. Within the set of filter rules is a rule that covers the selected object in the defined context. That rule would disclose the operations (in the form of a list) that be performed on that object in the defined context. The action selected by the user is received at the Action input Engine. In step 43, the Action input Engine produces a set of tasks (task list) and an input map). This set of tasks and maps is based on the input rules, current and the selected action for the object. In step 44, the Action Task Engines establishes the specific steps necessary to implement the task. Each task will comprise a set of steps to execute in order to run this task.

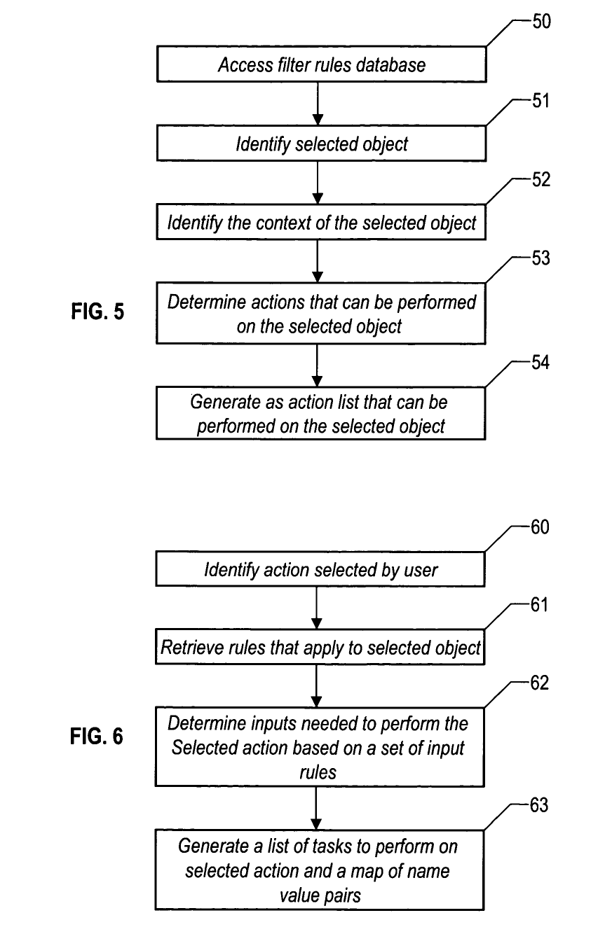

FIG. 5 is a flow diagram illustrating the steps in the action filter process (stage 1) of the present invention. The selection of a GUI object by the user would activate this process. The initial step 50 accesses the filter rules located in the filter rules database. The next step 51 would be to use the filer rules to identify the selected object. Following the object identification, step 52 would determine the context of the object. This step examines various conditions associated with selected object using the filter rules to determine the context of the object. Once there an identification of the object and a determination of the object context, step 53 determines the actions that can be performed on that object. In a different context, there would be a different set of actions for the selected object. Step 64 generates an action list containing the actions determined in step 53. This output list is presented in some form to the user in the form of the previously mentioned popup list. The end user then selects one of the actions from the list.

FIG. 6 is a flow diagram illustrating the steps in the action input process (stage 2) of the present invention. This stage determines the inputs that are necessary to perform the selected action. These inputs are internal inputs that are transparent to the end user. These internal inputs are derived from the action input rules based on the context of the selected object. In stage 2, step 60 identifies the action selected by the end user. Step 61 retrieves the input rules from the input database that will apply to the selected action. Step 62 applies the rules to the selected action based on the previously determined context of the selected object. In this step, the input rules are applied in order to determine the inputs that are needed to perform this selected action. After the identification of the inputs in step 62, the next step 63 is to generate a list of tasks that are needed to perform/implement the action. Step 53 also generates an input map. This map contains the identification of the inputs for each task and a value associated with that input. In the map, each value is identified by a fixed name in order for the process to know what values/input are associated with which tasks. In an implementation, when a task needs a certain input, the task can identify from input map, which value is the proper input for that task.

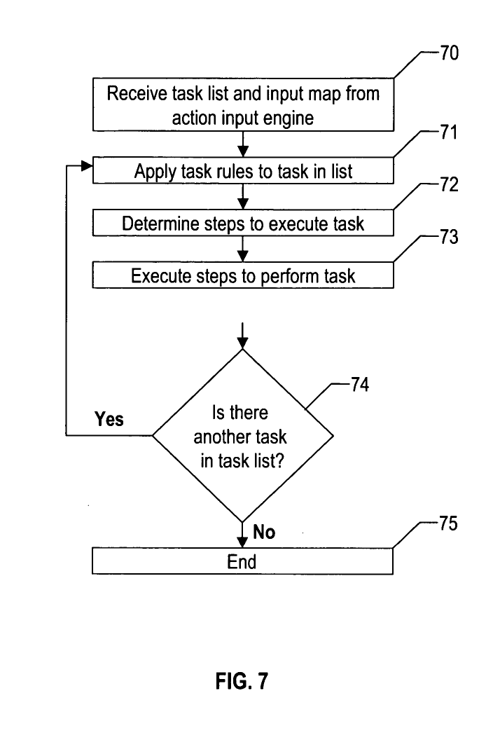

FIG. 7 is a flow diagram illustrating the steps in the action task process (stage 3) of the present invention. In this stage, the action task engine performs each task in the task list using the inputs in the input map. Step 70 receives the task list and input map from the action input engine. Step 71 retrieves a task from the list. Step 72 then applies the task rules to determine steps necessary to perform the task. Following this determination, step 73 performs the task using the determined steps and appropriate inputs from the input map. For example, it one of the tasks in the list was ‘Task A’, the task would determine that it is necessary to run a certain executable program on the computer. For a second task, there will be a different process. At the completion of this task, step 74 returns to the list and determines if there are other tasks on the list. If there are additional tasks on the list, the process returns to step 71. The process then repeats steps 71, 72 and 83 for each remaining task. If there are no additional in the list to be performed, the process will terminate at step 75.

FIG. 8 is a diagram illustrating a detained data flow sequence of the implementation of the method of present invention. These steps are illustrated in conjunction with FIG. 3. Step 80 creates the database that contains the filter, context and task rules is populated from a set of XML documents. This is an initialization step that is only done once for each new set of rules applies. Step 81 provides the Action Filter Engine with the current operating state of the user interface. In step 82, the Action Filter Engine accesses the filter rules to determine a set of actions that applies for the current context state. In step 83, the Action Filter Engine returns the list of actions as an output. At this point, an external actor/user selects an action from the list of actions in step 84. (This could be the user of a UI selecting the action from a menu of actions.). Step 85 provides the Action input Engine with the selected action and the current context state. In step 86, the Action input Engine accesses the input rules in order to generate a set of input name/value pairs (known as a input map) from the context state and determines a list of tasks to execute. In step 87, the Action input Engine returns the input map and the list of tasks as an input. Step 88 provides the Action Task Engine with the input map and the list of tasks. In step 89, the Action Task Engine accesses the task rules to determine how to execute the task list; then executes each task, providing the input map as input. In step 90, the Action Task Engine executes each task in the task list using the inputs from the input map.

The following example illustrates the implementation of the present invention in the computer system management application. In the example, the GUI object selected by the end user is a computer. One action that can be performed on a computer is the ability for one to reboot/restart the computer. This restart action would appear on the action list generated by the action filter engine. Other actions, such as ‘shut down’ or ‘hibernate’ could also appear on action list. From this action list, the user may select the restart action. At this point, the process moves to the action input engine, where there is a determination of any arguments that are needed to perform the restart operation. The action input engine will examine the input rules to determine what arguments are needed to perform this restart action. From the action input engine, one derived input may be to restart after a defined interval of time such as 10 seconds. In a different context, there may be a different time interval or no delay prior to the restart. This input would be in the input map generated by the action input engine. As mentioned, this input entry in the input map would have name such as ‘restart delay’ and a number ‘10’. This map goes to the action task engine. In reality, there may several operations to perform to accomplish this restart action. The action input engine would generate the set of tasks (task list) to be performed in the restart action. For example, the set of task may comprise: (1) shutting down all applications, (2) notifying the user and (3) restarting the machine. This task list and input map both go to the Action Task Engine. The Action Task Engine would determine how to execute each of the tasks based on the task rules. For example, in the task of shutting down the computer, the Action Task Engine would determine the steps in this process and use the input map data to execute the steps in this process.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A system for dynamic determination of actions to perform on a selected object in a graphic user interface environment comprising:
an action filter module that determines actions available through user inter-action with graphic user interface objects;
an action input module that determines tasks to perform a selected action available through a selected graphic user interface object;
an action task module that defines the operations needed to execute a determined task; and
rules used by said action filter module, context module and action task module for determining the corresponding actions, tasks and operations to be performed on an object.

2. The system as described in claim 1 wherein said rules comprise:
a set of filter rules;
a set of input rules; and
a set of task rules.

3. The system as described in claim 2 wherein said sets of rules are comprised of XML files.

4. The system as described in claim 2 further comprising a database in which said rules reside.

5. The system as described in claim 1 further comprising one or more object action lists generated by said action filter module.

6. The system as described in claim 5 further comprising one or more task lists generated by said action input module, a task list being based on a selected action from an action list.

7. The system as described in claim 6 further comprising an input map for each task list, said input map comprising a set of value pairs.

8. The system as described in clam 7 further comprising a set of steps generated by said action task module to execute a task in the task list.

9. The system as described in claim 4 wherein said database further comprises a filter rules database, an input rules database and a task rules database.

10. A method for dynamic determination of actions to perform on a selected object in a graphic user interface environment comprising the steps of:
determining the context of a selected object in a graphic interface environment;
defining the actions that can be performed on the selected object, said actions comprising an action list;
defining a set of one or more tasks necessary to implement an action selected from the action list; and
determining a set of operations necessary to perform a defined task.

11. The method as described in claim 10 further comprising the step of creating rules for use in said action defining step, said tasks defining step and said operations determining step.

12. The method as described in claim 10 wherein said context determining step further comprises the steps of:
identifying a selected object; and
applying a set of rules to the selected object.

13. The method as described in claim 12 wherein said action defining step further comprises the step of applying rules that define which operations can be performed on an object in a certain context.

14. The method as described in claim 13 wherein said task defining step further comprises the step of applying rules that define which tasks are required to be performed a selected action, said rules also defining a set of input values that are used to execute the defined tasks.

15. The method as described in claim 14 wherein said operations defining step further comprises the steps of:
applying rules that define the operations needed to perform a define task;
generating steps to implement a defined task; and
executing the task using appropriate input values.

16. A computer program product in a computer readable medium for dynamic determination of actions to perform on a selected object in a graphic user interface environment comprising:
instructions for determining the context of a selected object in a graphic interface environment;
instructions for defining the actions that can be performed on the selected object, said actions comprising an action list;
instructions for defining a set of one or more tasks necessary to implement an action selected from the action list; and
instructions for determining a set of operations necessary to perform a defined task.

17. The computer program product as described in claim 16 further comprising instructions for creating rules for use in said action defining instructions, said tasks defining instructions and said operations determining instructions.

18. The computer program product as described in claim 16 wherein said context determining instructions further comprise:
instructions for identifying a selected object; and
instructions for applying a set of rules to the selected object.

19. The computer program product as described in claim 18 wherein said action defining instructions further comprise instructions for applying rules that define which operations can be performed on an object in a certain context.

20. The computer program product as described in claim 19 wherein said task defining instructions further comprise instructions for applying rules that define which tasks are required to be performed a selected action, said rules also defining a set of input values that are used to execute the defined tasks.

21. The computer program product as described in claim 20 wherein said operations defining instructions further comprise:
instructions for applying rules that define the operations needed to perform a define task;
instructions for generating steps to implement a defined task; and
instructions for executing the task using appropriate input values.
